(19) United States
(12) Patent Application Publication
(10) Pub. No.: US 2012/0187222 A1
(43) Pub. Date: Jul. 26, 2012

(54) COOLING AND WASHING SYSTEM

(76) Inventor: Giora GALILI, Kibbutz Naan (IL)

(21) Appl. No.: 13/356,806

(22) Filed: Jan. 24, 2012

(30) Foreign Application Priority Data
Jan. 25, 2011 (GB) 1101239.0

(51) Int. Cl. B05B 3/18

(52) U.S. Cl. 239/751

(57) ABSTRACT

A cooling and washing system designed to evaporatively cool solar panels by sprinkling water upon the panels according to their temperature, in way that utilizes warm water from the system and minimizes water consumption, such as to keep the solar panel in an optimal operation temperature. Sprinkling is carried out by a moveable arm connected to a cart that is directed to the optimal sprinkling locations by a control system. The arm is designed to minimize shading on the panels, and to further allow cleaning the panels. The system may be operated by water power.

### BACKGROUND

1. Technical Field

The present invention relates to the field of solar energy appliances, and more particularly, to washing and cooling solar panels.

2. Discussion of Related Art

Solar systems suffer from energy losses due to heating and operation outside an optimal temperature, as well as from dust and dirt that reduce solar interception by the panels.

U.S. Pat. No. 7,258,057, which is incorporated herein by reference in its entirety, discloses an engine that is actuated by a pressurized water.

### BRIEF SUMMARY

Embodiments of the present invention provide an apparatus comprising: a track comprising two pulleys, one at each end of the track, and a spring loaded cord loop spanned between the pulleys; a cart moveably mounted on the track and connected to the cord; a motor connected to a motive one of the pulleys and arranged to rotate the motive pulley such as to move the cart along the track, wherein the motive pulley comprises a frictional element arranged to receive the cord and prevent slipping of the cord therefrom; a beam mounted on the cart transversely to the track arranged to support a plurality of water supplied sprinklers; and a controller arranged to control motion patterns of the cart and sprinkling patterns of the sprinklers according to specified rules.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIGS. 1A and 1B, 2A to 2F and 3A to 3D are schematic illustrations of an apparatus, according to some embodiments of the invention;

FIGS. 4A to 4F are schematic illustrations of a securing mechanism in the apparatus, according to some embodiments of the invention;

FIGS. 5A and 5B are schematic illustrations of sprinklers in the apparatus, according to some embodiments of the invention;

FIGS. 6A to 6E are schematic illustrations of a suction unit in the apparatus, according to some embodiments of the invention; and

FIGS. 7A to 7G are schematic illustrations of a modular beam extension system in the apparatus, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

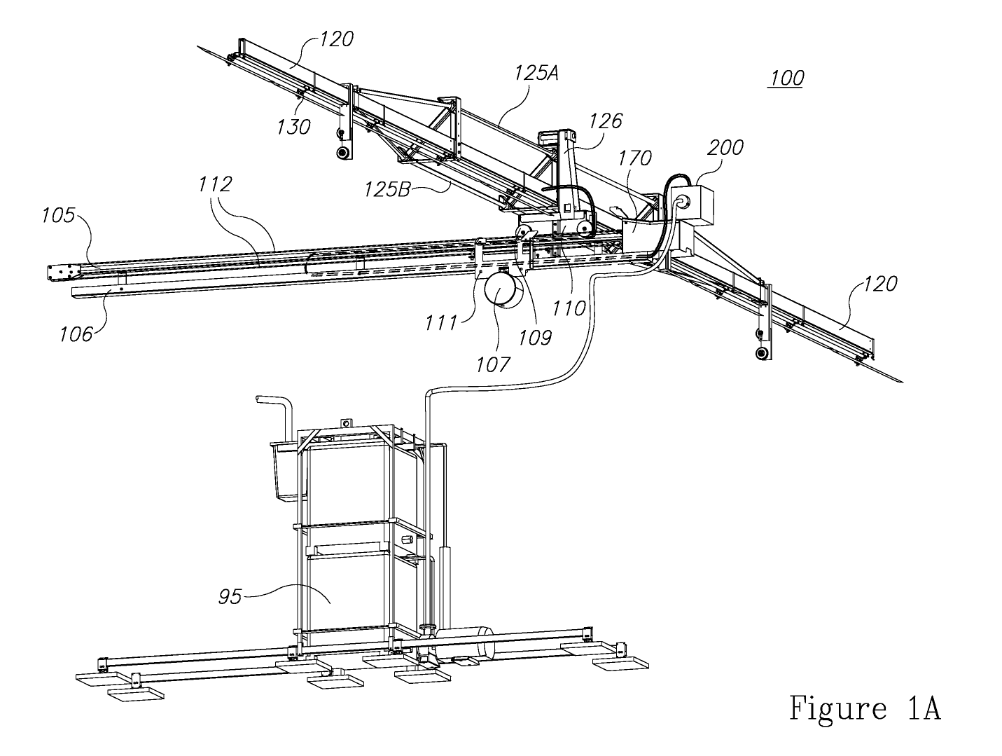

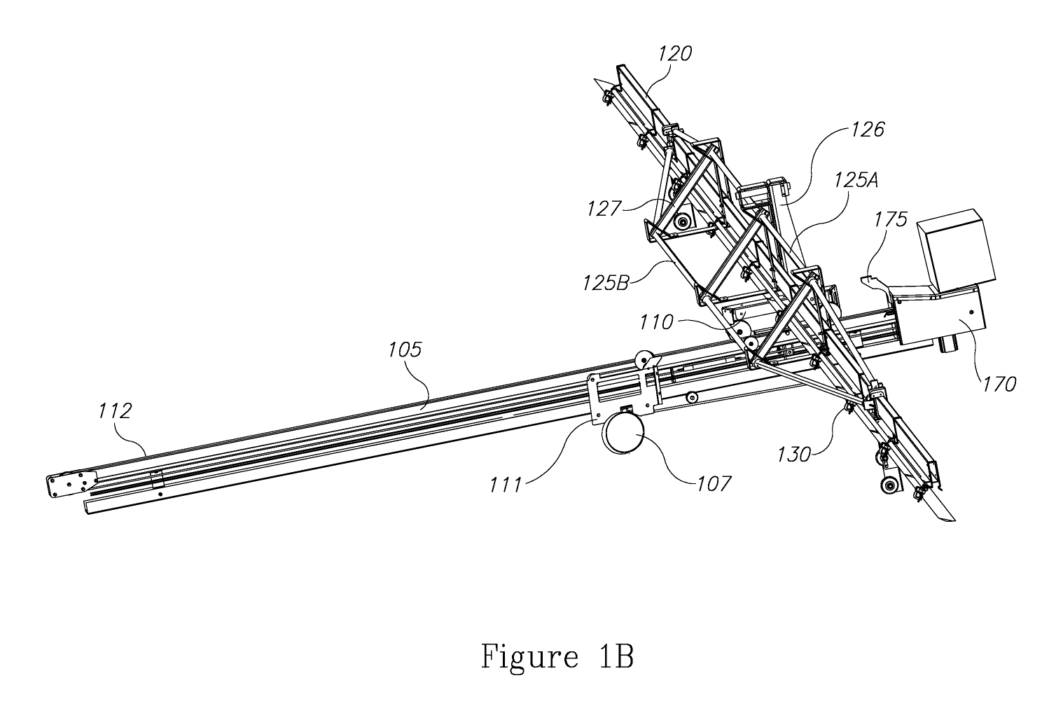

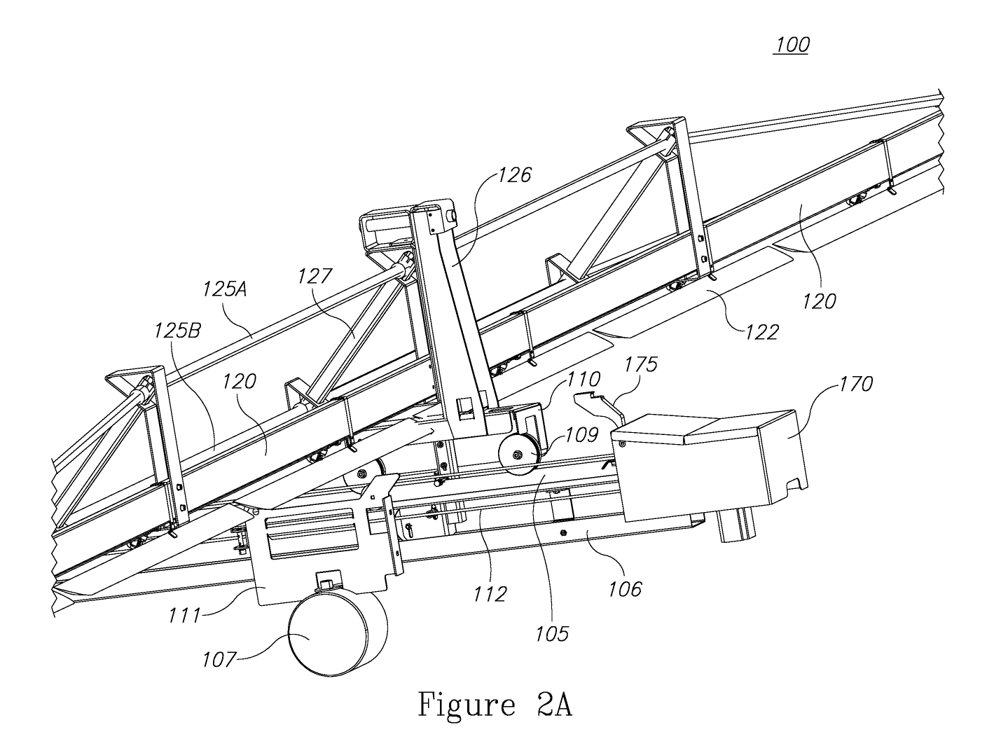

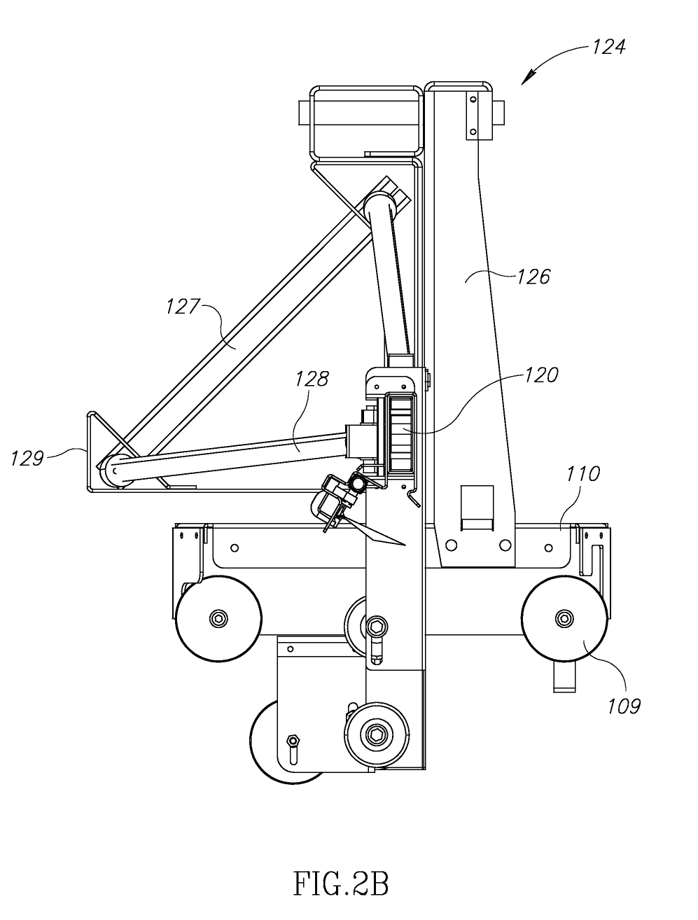

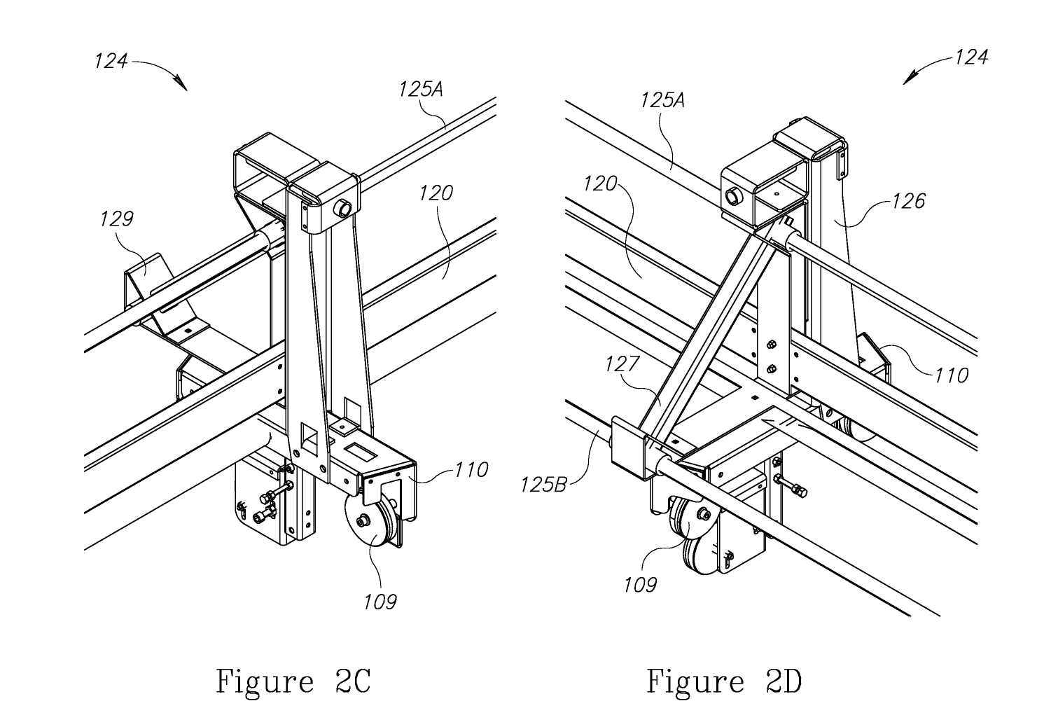

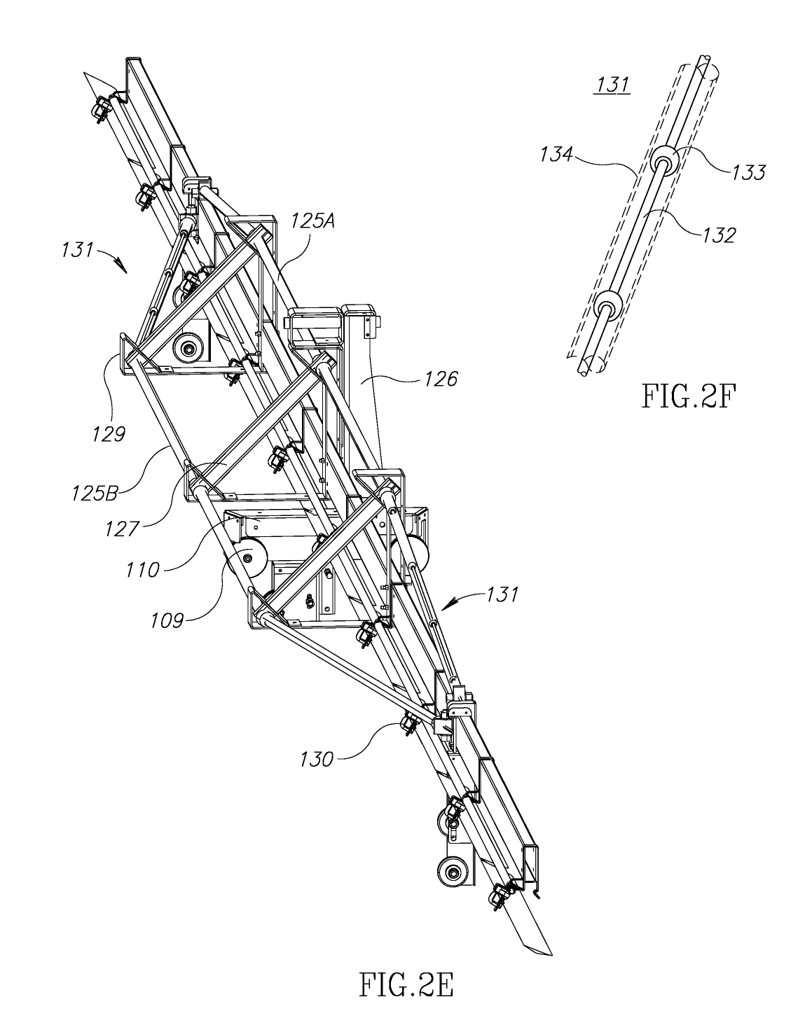

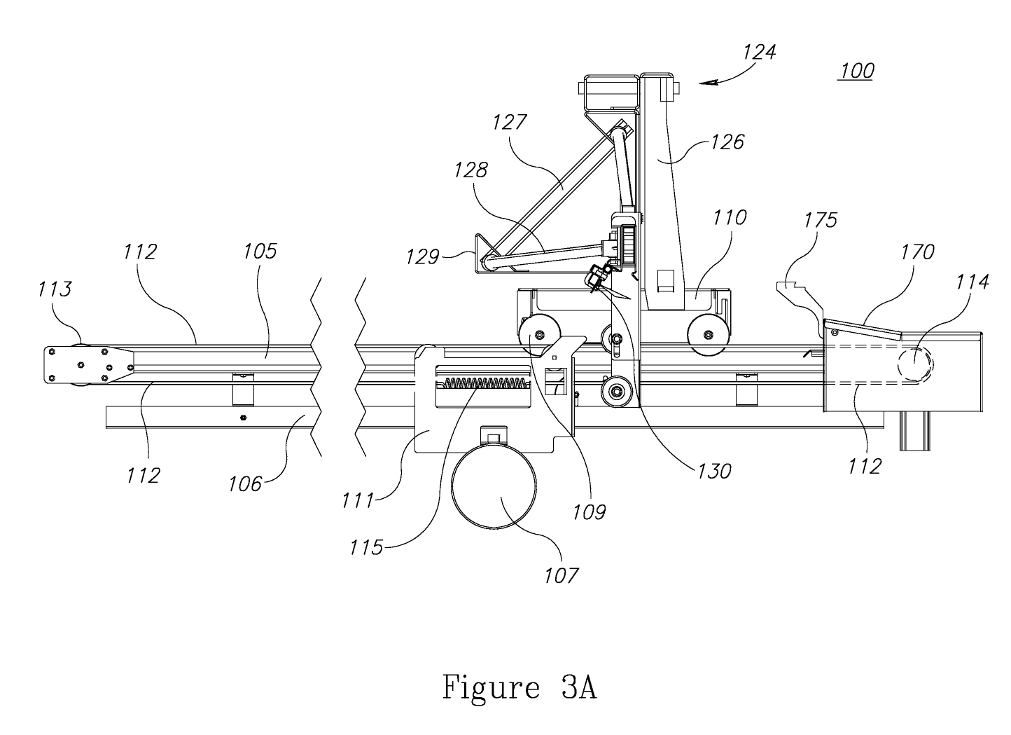

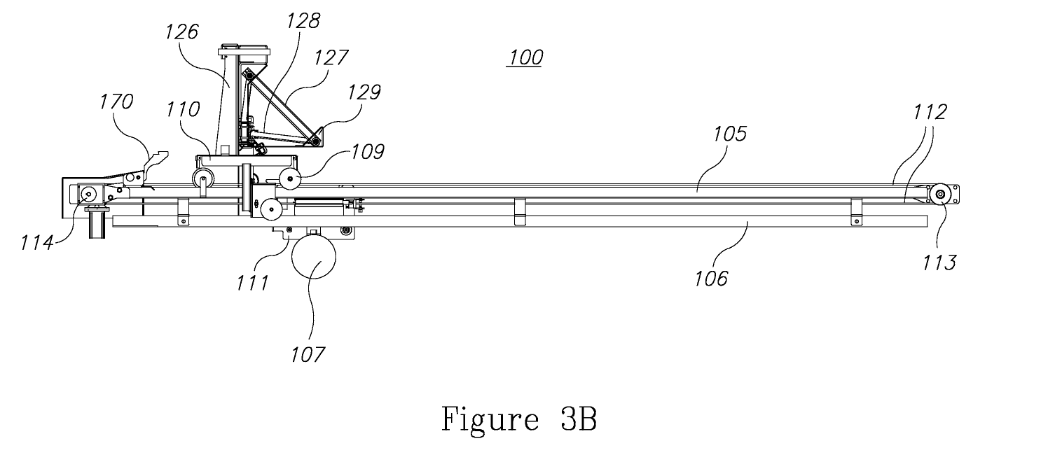

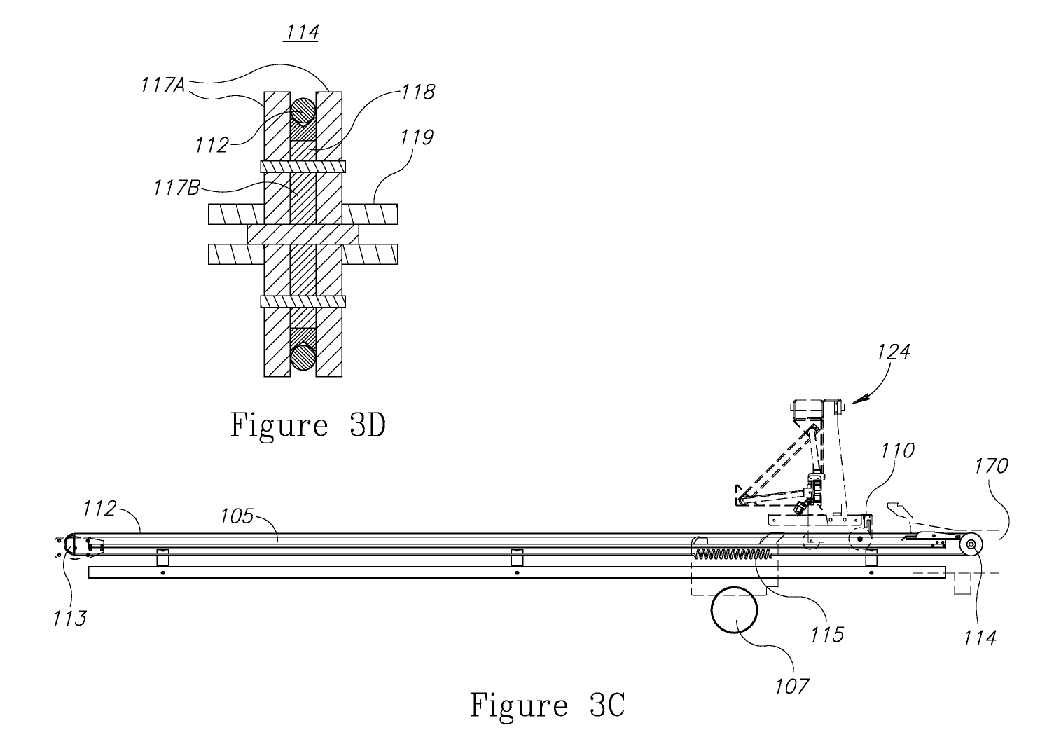

FIGS. 1A and 1B are perspective views of details of an apparatus 100, according to some embodiments of the invention; FIGS. 2A to 2F are schematic illustration of a cart 110 and a beam 120 with sprinklers 130 and a support system in apparatus 100, according to some embodiments of the invention; FIG. 3A to 3D are side views of apparatus 100 with a track 105 and a cord loop 112 used to move cart 110, according to some embodiments of the invention.

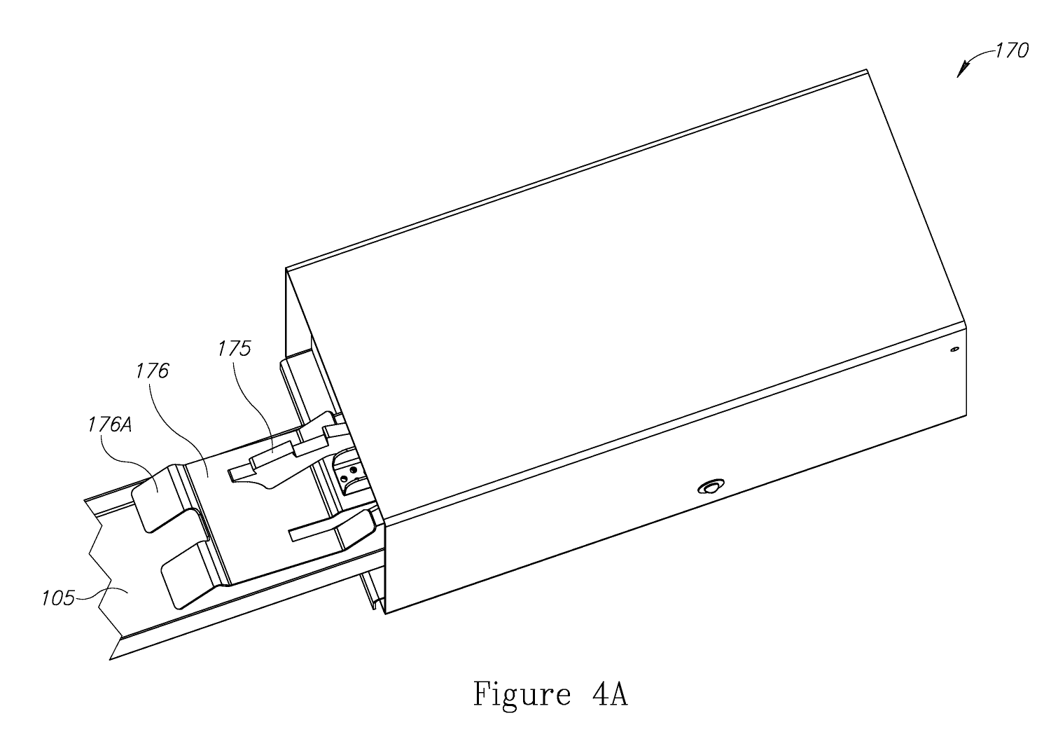

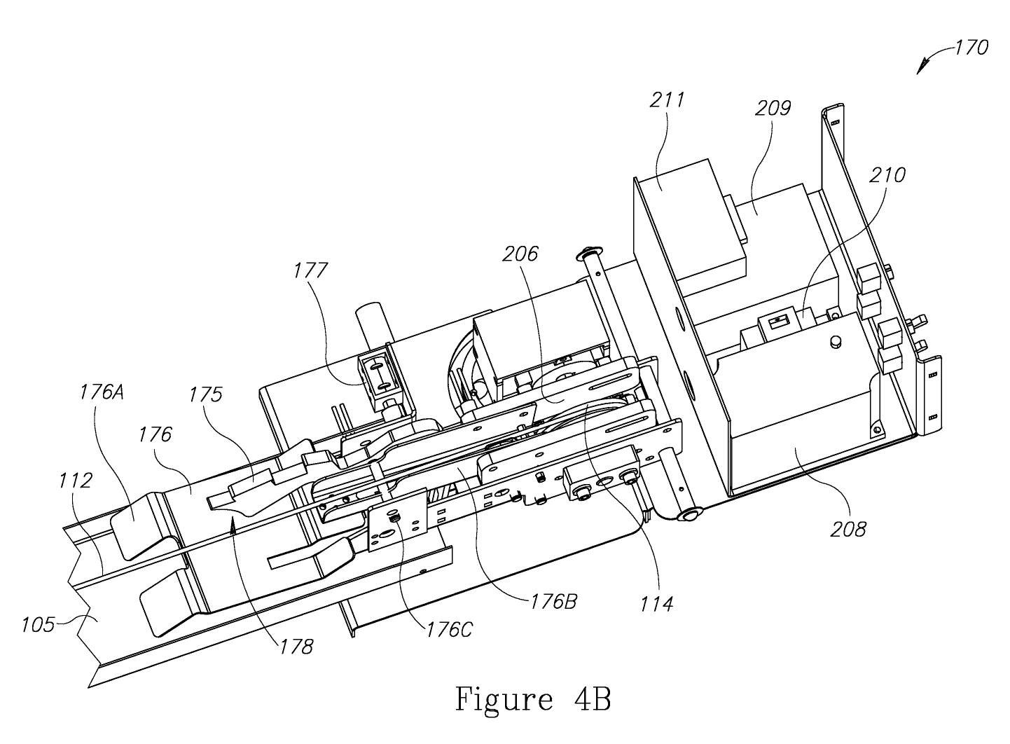

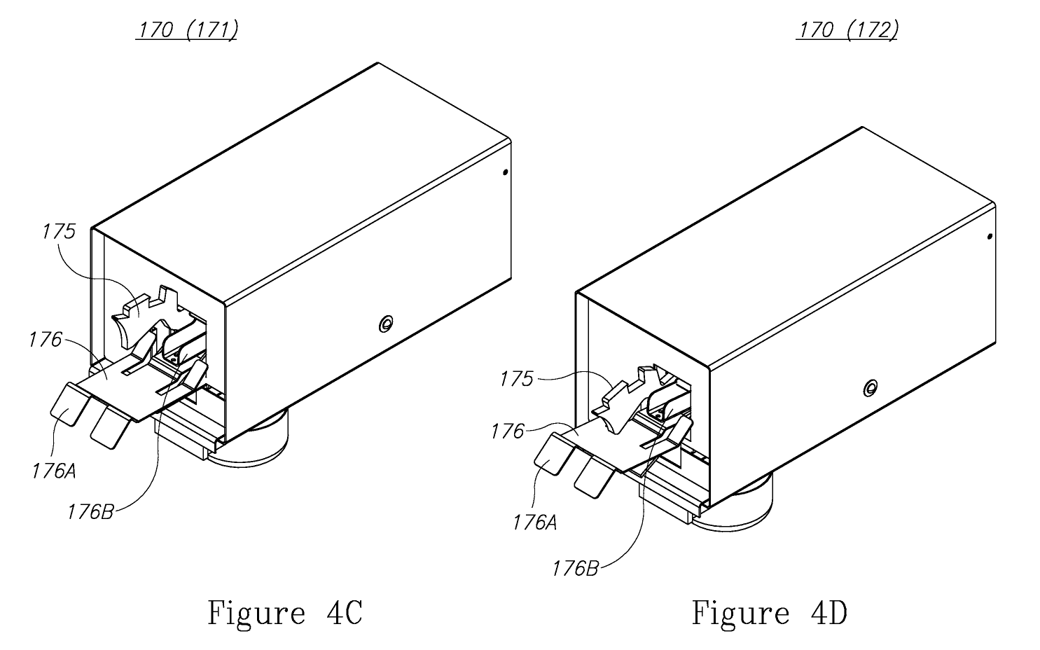

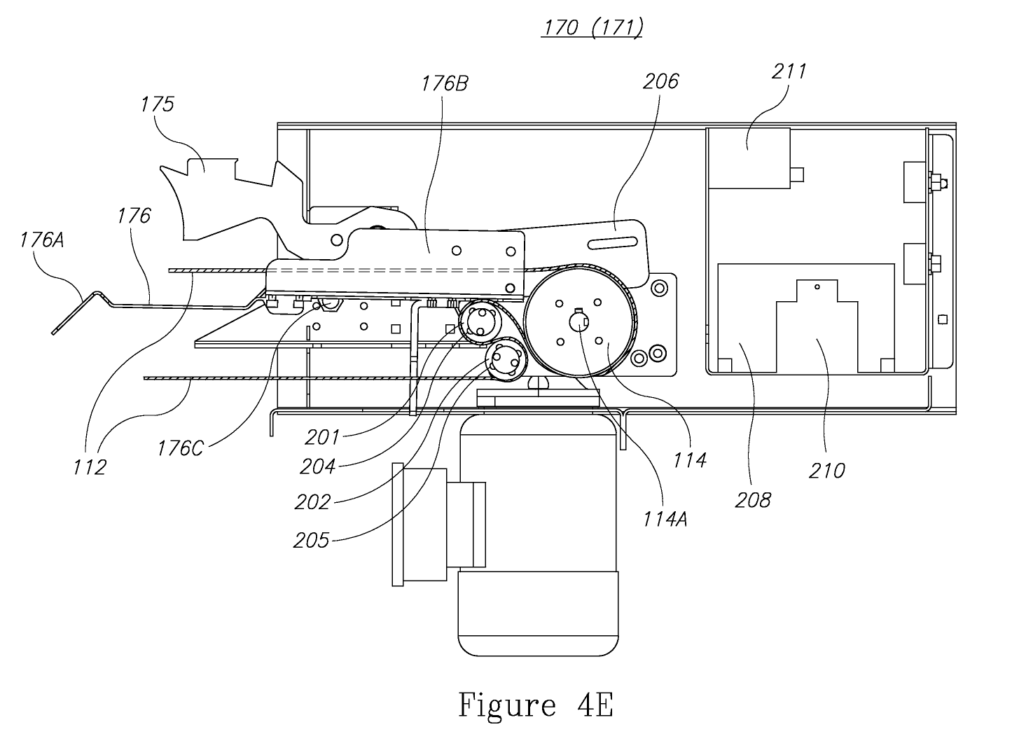

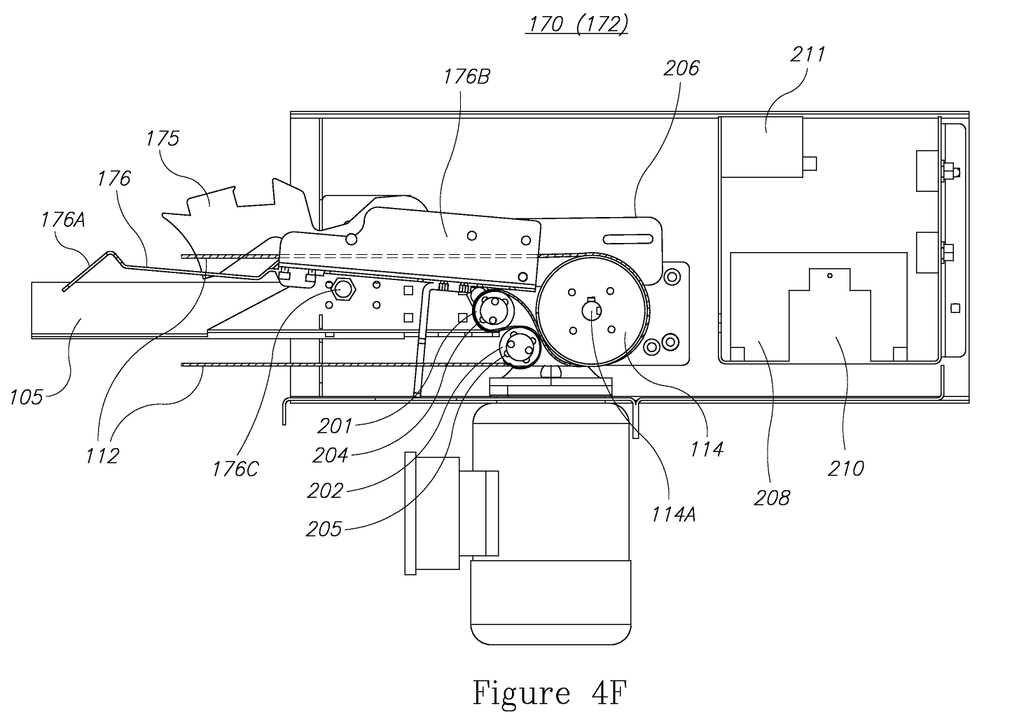

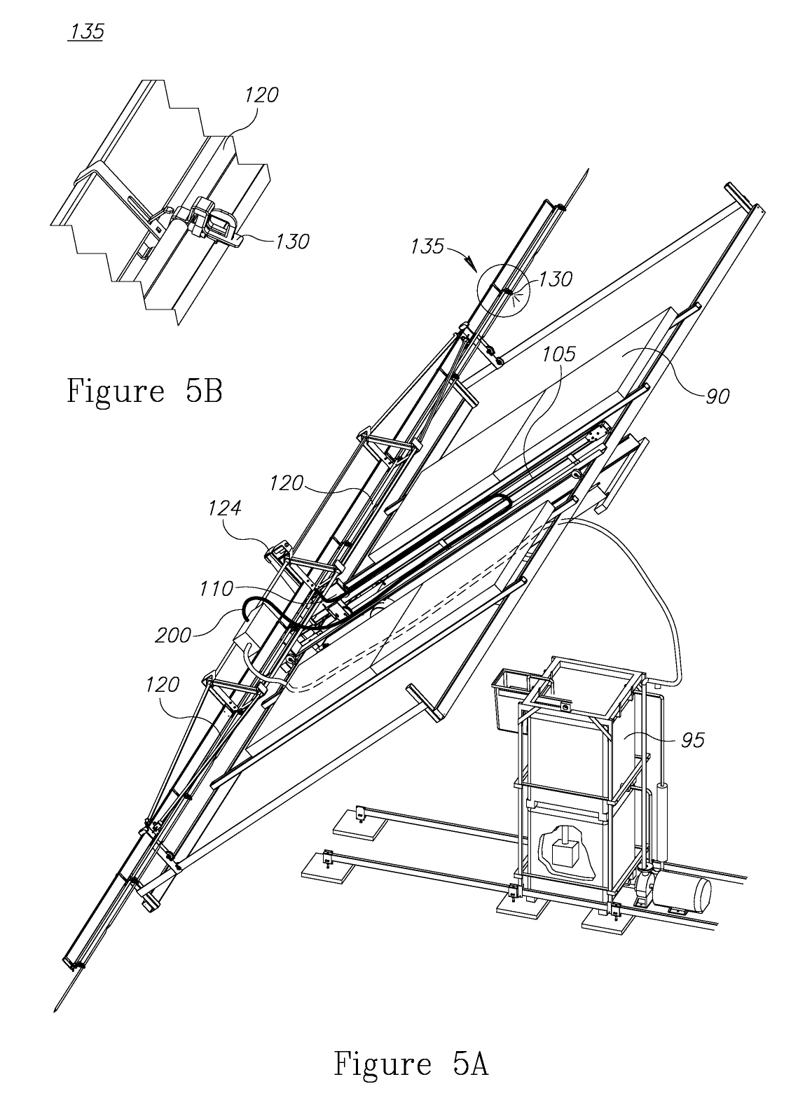

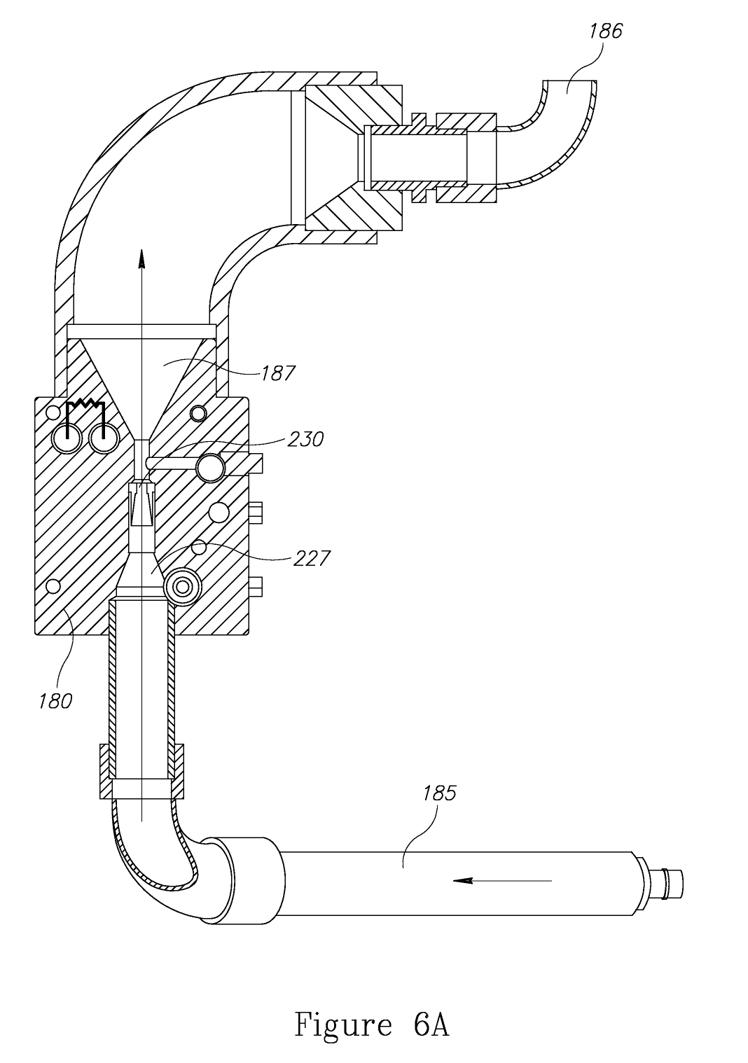

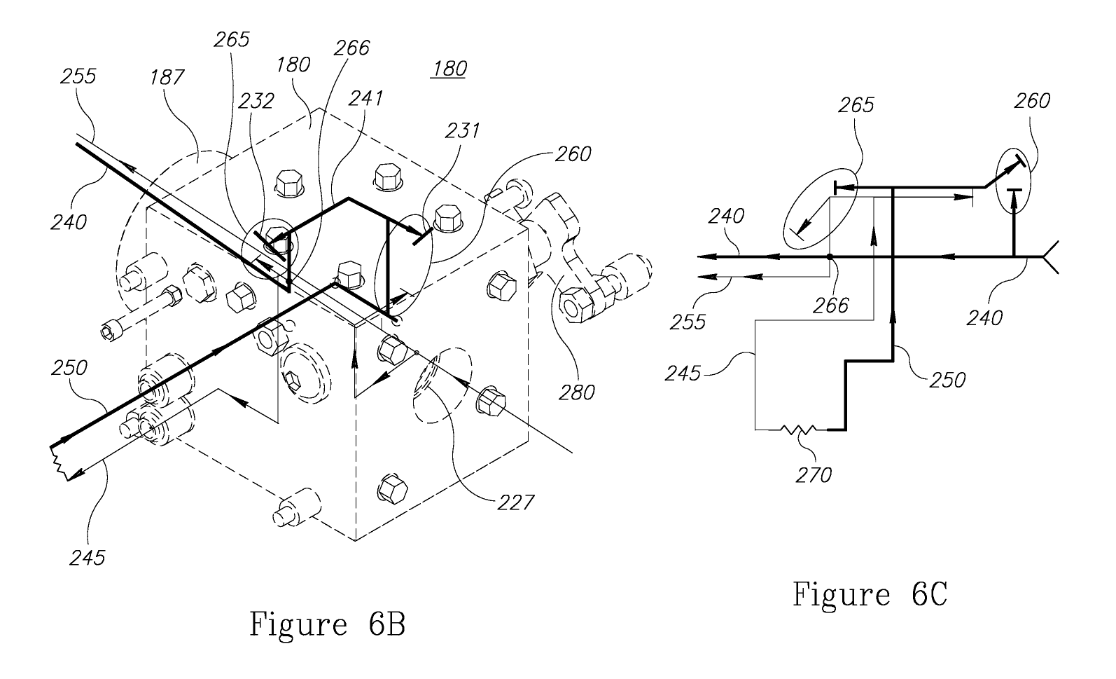

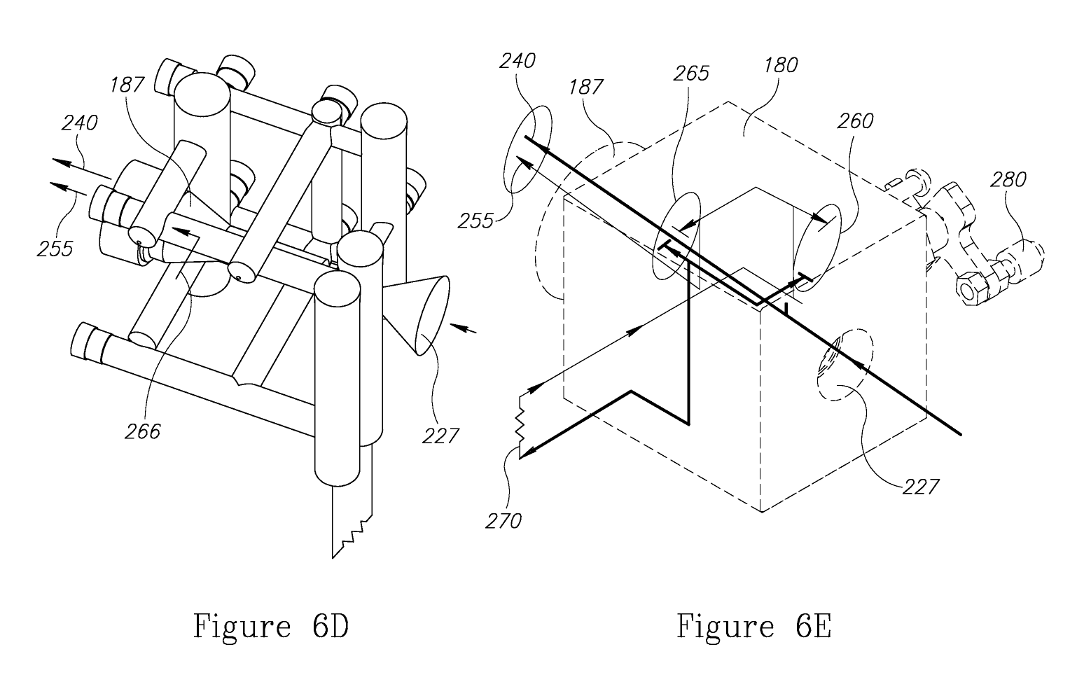

FIGS. 4A to 4F are schematic illustrations of a securing mechanism 170 in apparatus 110, according to some embodiments of the invention; FIGS. 5A and 5B are perspective view of sprinklers 130 in apparatus 100 for cleaning solar panels 90, according to some embodiments of the invention; and FIGS. 6A to 6D are schematic illustrations of a suction unit 180 in apparatus 100, according to some embodiments of the invention.

Apparatus 100 comprises a track 105 comprising two pulleys—a motive pulley 114 and a support pulley 113, one at each end of track 105, and a spring (115) loaded cord loop 112 spanned between pulleys 113, 114. Cart 110 is moveably mounted on track 105 and connected to cord 112.

A motor (not shown) is connected to motive pulley 114 (e.g. via connector 114A) and arranged to rotate motive pulley 114 such as to move cart 110 along track 105.

Motive pulley 114 comprises a frictional element 118 (FIG. 3D) arranged to receive cord 112 and prevent slipping of cord 112 therefrom. For example, frictional element 118 may comprise an O-ring supported on an inner disc 117B that is affixed between two external discs 117A on an axis 119. Frictional element 118 assures the rotation of cords 112 together with motive disc 114 such that power from the motor is used to move cart 110 via cord 112.

Apparatus 100 comprises a beam 120 mounted on cart 110 transversely to track 105. Beam 120 is arranged to support a plurality of water supplied sprinklers 130. sprinklers 130 are arranged to cool and clean solar panels 90 by sprinkling water with a high intensity upon solar panels 90. Cleaning is achieved by the intensity of sprinkling and cooling is achieved by the evaporation of the water. Excessive water may be collected and reused. The sprinkled water may be sprinkled in variously designed beams, according to their use and required characteristics. Water may be provided from the water network or from containers 95 via an input pipe 185.

Apparatus 100 comprises a controller (not shown) arranged to control motion patterns of cart 110 and sprinkling patterns of sprinklers 130 according to specified rules.

The motor may be a stepper motor, a DC motor or an AC water. In embodiments, the motor is a water motor that is operated by the water that is used for sprinkling Suction element 180 may be connected to water motor 270 to enhance water pressure.

Cart 110 is balanced by a weight 107 along its direction of movement and balanced by wheels 109 on sides of track 105. Weight 107 may be arranged to balance a weight of cart 110 in respect to an incline of track 105. In this arrangement, cart 110 may practically move in a state close to equilibrium such as to minimize strains of the system. Friction may be reduced by using metal tack 105 and plastic wheels 109. Spring 115 is arranged to maintain the tension of cord 112, especially in oblique and vertical orientations of track 105. Track 105 may be supported by a bar 106.

Beam 120 may be supported by suspension support 124 (FIGS. 2A-2F) arranged to keep beam 120 straight in all orientations and loads, as well as to minimize shading of solar panels 90. Moreover, beam is stabilized by suspension support 124 such as to avoid transferal of moments to cart 110 and track 105. Beam 120 and suspension support 124 may be stabilized internally to minimize their cross-section.

Suspension support 124 may comprise two rods 125A, 125B parallel to beam 120 such as to balance the weight of beam 120 (supporting water pipes for sprinklers 130) in two directions corresponding to tilting angles of track 105 (e.g. in the direction of track 105 and perpendicular to track 105). Rods 125A, 125B may be held by a frame 129, stabilized by a cross-beam 127 and mounted on cart 110 by basis 126. Rods 125A, 125B may comprise a structure 131 having a taut cord 132 (FIG. 2F) within an envelope 134. Tension in cord 132 may be adjusted by a nipple 133 within envelope 134. Rods 125A, 125B may comprise taut cord 132 or may be connected to elements that are strengthened by internal taut cord 132.

Hanging beam 120 from suspension support 124 may allow lowering its profile and generate a retrieving and balancing force. The height of beam 120 may be adapted to panels 90, and may be determined by mounting them on a narrow pole connected to track 105. Beam 120 and suspension support 124 may be constructed of light and strong materials.

Apparatus 100 comprises a controller 209 that is arranged to control motion patterns of cart 110 and sprinkling patterns of sprinklers 130 according to measurements related to solar panels 90 and/or specified rules. For example, controller 209 may compare power supply from solar panels 90 before and after cleaning and cooling, to determine a timing for another activation. Controller 209 may measure or derive a temperature of solar panels 90 and operate sprinklers 130 accordingly. Controller 209 may be arranged to maintain by successive sprinkling a specified temperature of solar panels 90, or maintain the temperature of solar panels 90 within a specified range.

Track 105 and beam 120 may be arranged to be modularly extendable, such as to adapt to various configurations of solar panels 90, as well as for various configurations relating to other uses such as cleaning windows (e.g. in high rise building) and irrigation. Apparatus 100 may be operated to maintain a humidity level, and may be structure as a closed loop.

FIGS. 4A to 4F are schematic illustrations of securing mechanism 170 in apparatus 110, according to some embodiments of the invention.

Apparatus 100 may further comprise a fastening mechanism 170 at a lower side of track 105. Fastening mechanism 170 is arranged to fixate cart 110 in case of its disconnection from water motor 140. Such disconnection may result from a technical problem that may occur in apparatus 100, from external conditions such as a storm that exceed specified threshold, or from disconnection of power supply to apparatus 100, such as at the end of the day, in cases apparatus 100 is fed by electricity from solar panels 90 themselves. Fastening mechanism 170 may be further designed for securing critical components of apparatus 100 such as cart 110 against theft. Locking of fastening mechanism 170 may be carried out either mechanically or electronically.

Fastening mechanism 170 comprises an unlocked state 172 and a locked state 171. In locked state 171 a protrusion 175 is raised to hold cart 110. Protrusion 175 may be raised by an extension 176 (at notch 178) that is arranged to be pushed by cart 110.

Cart 110 pushes against an end 176A of extension 176, which raises a rear end 176B of extension 176, and may be sensed by sensor 176C as an indication of cart 110 reaching an end of its course.

When cart 110 is e.g. disconnected from cable 112 as a result of overload, disconnection, storm etc., cart 110 moves onto and pushes extension 176 (held by arm 206) to raise protrusion 175 and lock cart 110 in location. Protrusion 175 may be returned to its original position by the weight of its rear part 206. Locking cart 110 may be carried out by solenoid 177 pushing a pin into a hole in protrusion 175 thereby locking it and cart 112. Controller 210 may be arranged to release the pin at user selection.

Cord 112 may be associated with two rotary controllers 201, 202 having each four openings 204, 205 arranged to optically determine the positions of cord 112 and pulley 114. Cord 112 may be installed to rotate rotary controllers 201, 202 during its movement. The optical detection may be carried out by a sensor on one side of rotary controllers 201, 202, that is arranged to sense light from LEDs on the other side, as the light passes through openings 204, 205. Motive pulley 114 may comprise a perforated disc coupled with optics arranged to indicate rotation parameters thereof.

Controller 210 receives data from rotary controllers 201, 202, and speed regulator 208 regulates the rotation speed of motive pulley 114 accordingly, such as to avoid tearing of cord 112.

A breaking system integrated in fastening mechanism 170 allows moving cart 110 at high speed, thus avoiding unnecessary shading of solar panels 90.

FIGS. 6A to 6E are schematic illustrations of a suction unit in the apparatus, according to some embodiments of the invention.

A suction element 180 is connected to an output of a water motor 270 and is arranged to pump water from the output of water motor 270 to drive the water to sprinklers 130. Sprinklers 130 are connected to beam 120 and are supplied with water pumped by suction element 180 from the output of water motor 270.

Suction element 180 may utilize the venturi principle between input 227 and output cone 187 to generate a suction of the water exiting the water such as to raise the water pressure. Suction element 180 may be designed as a single element that also switch the water flow such as to operate water motor 270 in opposing directions according to the movement of cart 110. Water motor 270 may change its operation with direction change of cart 110. Suction element 180 may divert the direction of water flow and maintain the application of the venturi principle in both operational modes.

Suction element 180 may receive water at input 185 and pressurize the received water at output 186. Water direction within suction element 180 may be controlled by the movement of cart 110, for example a first system of tubes within suction element 180 may direct the water during one direction of cart movement, while a second system of tubes within suction element 180 may direct the water during cart movement in the opposite direction. The first system is illustrated by flows 240 and 250, the second system by flows 245, 255, and the coupling with the cart movement is denoted by stops 231, 232 associated with inductors 260, 265 (respectively) (FIG. 6B) which may be arranged to influence cart movement or be coupled with sensors of cart movements. In embodiments a secondary flow 245 may be split from a main flow 240 (at point 266) and directed through water motor 270 (depicted as a resistance in FIGS. 6B, 6C and 6E) to flow 250, and return flow 250 to the main flow. The venturi pump raises the pressure difference across water motor 270 and increases its power. In experiment, the inventor has raised the pressure across water motor 270 by 0.6 bar (from 3.5 bar to 4.1 bar). Suction element 180 is used to spare voluminous pipes and is designed as a single block.

Apparatus 100 may be mounted upon a building, by using a vertical track 105 and adjusting weight 107 to balance the weight of cart 110. In this configuration apparatus 100 may be used to automatically wash windows, or integrated solar panels 90, of the building by applying sprinklers 130 thereupon. Cart 110 may be pulled from wither side of track 105.

FIG. 5A illustrates apparatus 100 mounted above solar panels 90 and arranged to clean and evaporatively cool solar panels 90 by sprinkling water with a high pressure thereupon.

Apparatus 100 may be mounted to clean and cool a plurality of solar panels 90 in various configurations, and one or more apparatuses 100 may be used to clean and cool various geometric and geographic constellations of solar panels 90. Apparatus 100 is mounted above solar panels 90 and is arranged to clean solar panels 90 with the sprinkled water and to cool solar panels 90 by evaporation of the sprinkled water.

Apparatus 100 may further comprise a water collector arranged to collect water flowing off solar panels 90, purify the collected water and feed the purified water into container 95 or input pipe 185.

Apparatus 100 may further comprise at least one thermometer 220 arranged to measure a temperature of at least one of solar panels 90. Controller 209 may be arranged to sprinkle solar panels 90 such as to keep the temperature within a specified range. Controller 209 may be associated with speed regulator 208, control unit 210, control cover 209 arranged to control air cooling of the system, and a transformer 211. Control unit 210 may comprise a PLC unit and may have analog and digital component, or comprise a digital controller.

Apparatus 100 may be mounted on a greenhouse (not shown) with solar panels 90 and apparatus 100 mounted on a roof of the greenhouse and arranged to provide both energy and irrigation to the greenhouse.

The disclosed invention comprises a cooling and washing system designed to evaporatively cool solar panels 90 by sprinkling water upon panels 90 according to their temperature. Cooling and washing may be applied to surfaces of varying forms and sizes, including large and uneven surfaces.

Apparatus 100 may utilize warm water from the solar system and minimize water consumption, such as to keep solar panel 90 in an optimal operation temperature. Apparatus 100 may further recycle sprinkled water and reuse it after filtration for further cooling and washing. The water may be sprinkled at an intensity that prevents damage to panels 90 while effectively cleaning them.

Apparatus 100 may manage warm water for different purposes, e.g. collect water at 50-60° from the solar system, cool panels 90 with the water, collect the water and utilize the warm water for various needs.

Sprinkling is carried out by a moveable arm comprising beam 120 connected to cart 110 that is directed to the optimal sprinkling locations by controller 209. The arm may be adapted modularly to the panel forms and sizes.

Movement patterns of cart 110 and the arm may be pre-programmed or adapted to real time measurements of panel temperature, measurements associated with dust level on panels 90, e.g. from power production measurements or optical or electronic surveillance appliances.

Control of operation may be achieved by controlling few parameters, such as cart speed, water pressure, water supply, a temporal program, solar power production.

The arm is designed to minimize shading on panels 90, and to further allow cleaning panels 90.

Apparatus 100 may be operated by water power supplied by water motor 270, and possibly enhanced by a specifically designed component, such as suction element 180.

Apparatus 100 may be programmed to allow day cooling and night washing of panels 90. Controller 209 may be arranged to automatically activate a first cooling procedure at the break of dat. Controller 209 may be arrange to compare the power generated by the solar system before and after cleaning, and generate from the comparison indications of the effectivity of the cleaning, and use the indications to decide if further cleaning is needed.

Cart 110 may be balanced along track 105 by weight 107, and sidewise by wheels 109. Moving cart 110 may be carried out by pulling on two opposing cables 112. Track 105 and cart 110 may be designed to minimize the frictional forces between them. For example, air bearings may be used between cart 110 and track 105. Overall, track 105 is a compound track comprising movement tracks for cart 110, weight 107, piping, wheels 109, and cables 112.

Cables 112 may be activated by a motor controlling the tension in cables 112, and associated with positional sensors for identifying critical positions of cart 110 and weight 107.

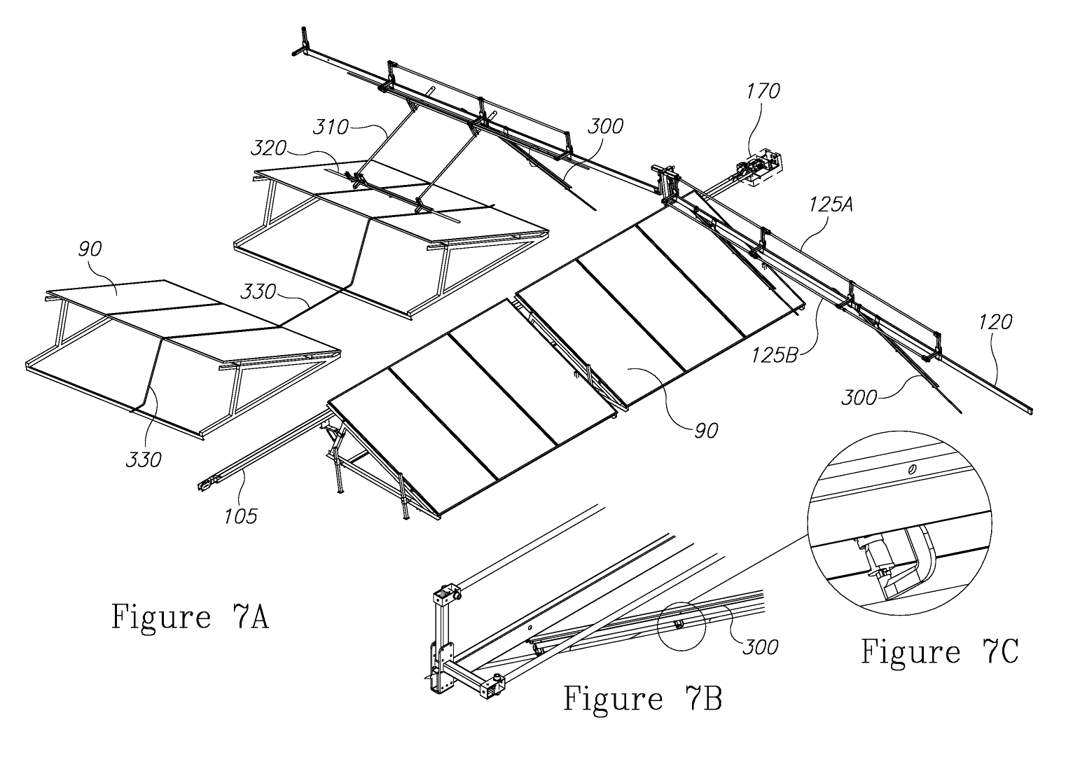

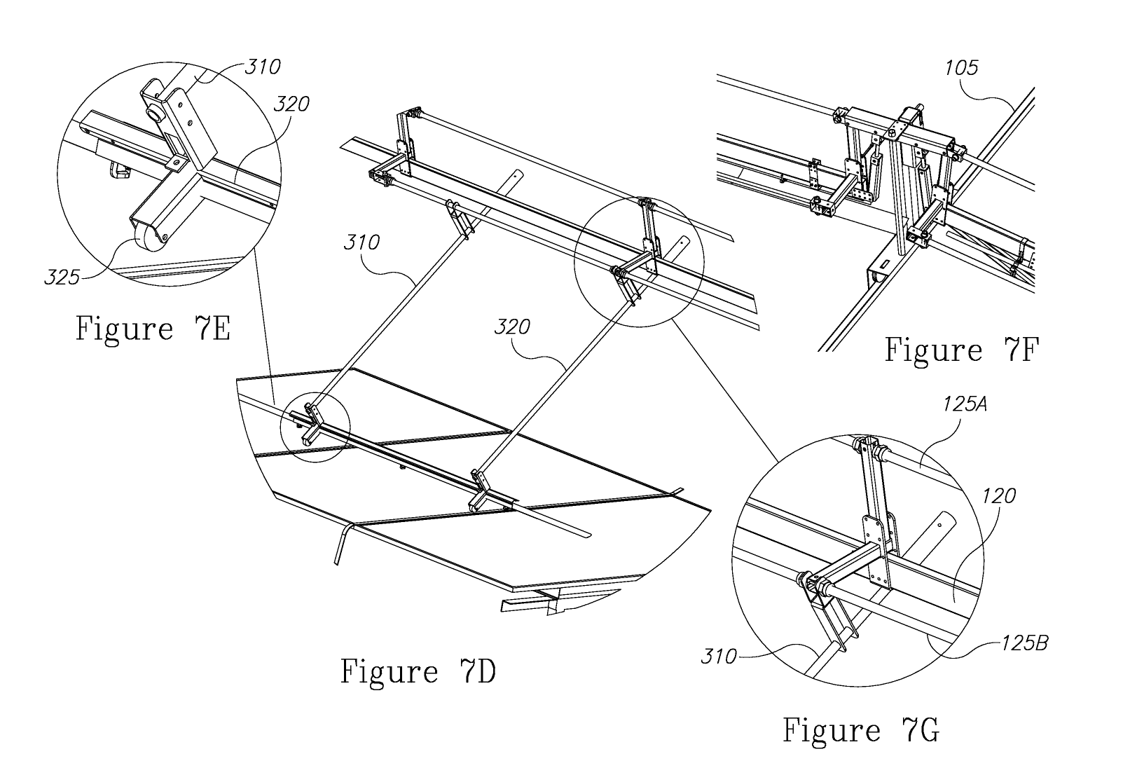

FIGS. 7A to 7G are schematic illustrations of a modular beam extension system in the apparatus, according to some embodiments of the invention.

Beam 120 may be extended in various ways to allow cooling and washing an elaborate array of solar panels 90. Beam 120 may comprise extensions 300 that facilitate moving sprinklers 130 at a specified distance from an uneven surface, such a jigsaw roof. Extensions 300 may be modularly connected to beam 120 according to specific installation locations. For example extensions 300 may be obliquely connected to beam 120. Another example is connecting extensions 320 by supports 310 to beam 120, and configuring supports 310 and extensions 320 to follow a specified formation of the solar panel array. Extensions 320 may be supported by wheels 325 onto solar panels 90, the wheels may be arranged to follow paths 330 in the solar panel array. Beam 120 may comprise cantilevers adjustably connected to each other (FIG. 7F). Beam 120 may further comprise a ballast (not shown) to balance beam 120 on track 105 in cases beam 120 is connected or loaded asymmetrically in respect to cart 110.

Apparatus 100 may be produced from recyclable materials and adapted for mass production at large and small scales.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An apparatus comprising:
a track comprising two pulleys, one at each end of the track, and a spring loaded cord loop spanned between the pulleys;
a cart moveably mounted on the track and connected to the cord;
a motor connected to a motive one of the pulleys and arranged to rotate the motive pulley such as to move the cart along the track, wherein the motive pulley comprises a frictional element arranged to receive the cord and prevent slipping of the cord therefrom;
a beam mounted on the cart transversely to the track arranged to support a plurality of water supplied sprinklers; and
a controller arranged to control motion patterns of the cart and sprinkling patterns of the sprinklers according to specified rules.

2. The apparatus of claim 1, wherein the track is horizontal.

3. The apparatus of claim 1, wherein
the track is inclined,
the apparatus further comprises a weight moveably mounted on the track on an opposite side of the track in respect to the cart and connected to the cord, such as to counterbalance the weight of the cart.

4. The apparatus of claim 1, wherein the beam is supported by at least one suspension support arranged to balance a weight of the beam and the water filled sprinklers.

5. The apparatus of claim 4, wherein the at least one support comprises internally a taut cord.

6. The apparatus of claim 3, wherein the beam is supported by two suspension supports arranged to balance a weight of the beam and the water filled sprinklers in horizontal and vertical directions.

7. The apparatus of claim 1, wherein
the motor is a water motor having an input and an output,
the apparatus further comprises a suction element connected to the output of the water motor and arranged to pump water from the output of the water motor, and
the sprinklers are supplied with water pumped by the suction element from the output of the water motor.

8. The apparatus of claim 1, wherein the motive pulley comprises a perforated disc coupled with optics arranged to indicate rotation parameters of the motive pulley.

9. The apparatus of claim 1, further comprising a fastening mechanism at a lower side of the track, arranged to receive and fixate the cart in case of malfunction.

10. The apparatus of claim 1, arranged to be mounted upon a building, by using a vertical track and adjusting the weight, to allow washing windows of the building by applying the sprinklers thereupon.

11. A system comprising:
a plurality of solar panels; and
the apparatus of claim 1 mounted above the solar panels and arranged to clean the solar panels by sprinkling water thereupon and to cool the solar panels by evaporation of the sprinkled water.

12. The apparatus of claim 11, wherein the track and the beam are modularly extendable to maintain a proximity of the sprinklers to the solar panels.

13. The system of claim 11, further comprising a water collector arranged to collect water flowing off the solar panels, purify the collected water and feed the purified water into the input of the water motor.

14. The system of claim 11, further comprising at least one thermometer arranged to measure a temperature of at least one of the solar panels, and wherein the controller is arranged to sprinkle the solar panels such as to keep the temperature within a specified range.

15. The system of claim 11, further comprising a greenhouse, wherein the solar panels and the apparatus are mounted on a roof of the greenhouse and arranged to provide both energy and irrigation to the greenhouse.
